(19) United States
(12) Patent Application Publication
(10) Pub. No.: US 2018/0196125 A1
(43) Pub. Date: Jul. 12, 2018

(54) SYSTEMS AND METHODS FOR LIDAR INTERFERENCE MITIGATION

(71) Applicant: QUALCOMM Incorporated, San Diego, CA (US)

(72) Inventor: Linda Irish, San Diego, CA (US)

(21) Appl. No.: 15/401,966

(22) Filed: Jan. 9, 2017

(51) Int. Cl. G01S 7/48; G01S 17/08

(52) U.S. Cl. CPC G01S 7/4802; G01S 17/08

(57) ABSTRACT

Systems and methods for LIDAR interference mitigation are disclosed. One disclosed system includes: a beam transmitting device configured to transmit a light beam; an optical detector comprising a plurality of pixels, each of the plurality of pixels configured to generate a detection signal in response to detecting incident light, wherein the incident light comprises a reflection of the light beam from an object; and an analog circuit coupled to one or more of the plurality of pixels and configured to compare one or more of the detection signals to a reference signal and output a comparison signal associated with the one or more of the plurality of pixels.

### BACKGROUND

Light beams may be used to measure distances between objects. By way of example, a light detection and ranging (LIDAR) system is an active remote sensing system that can use light beams to obtain the range, i.e., distance, from a source to one or more points on a target. A LIDAR system uses a light beam (typically a laser beam) to illuminate at least a portion of the target and measures the time it takes for the emitted light beam from the source to arrive at the target and then return to a detector near the source or at a known location. In other words, the range from the source to the point on the target can be determined based on the time-of-flight (ToF) of the light beam from the source to the detector. To measure ranges to multiple points on a target or in a field-of-view of the LIDAR system, the laser beam is usually scanned in one or two dimensions. In various implementations of the LIDAR system, it is desirable to reduce interference from other LIDAR beams.

### BRIEF SUMMARY

In one embodiment, a system for LIDAR interference mitigation comprises: a beam transmitting device configured to transmit a light beam; an optical detector comprising a plurality of pixels, each of the plurality of pixels configured to generate a detection signal in response to detecting incident light, wherein the incident light comprises a reflection of the light beam from an object; and an analog circuit coupled to one or more of the plurality of pixels and configured to compare one or more of the detection signals to a reference signal and output a comparison signal associated with the one or more of the plurality of pixels.

In another embodiment, a method for LIDAR interference mitigation comprises: controlling a beam transmitting device to transmit a light beam; detecting incident light with an optical detector comprising a plurality of pixels, each of the plurality of pixels configured to generate a detection signal in response to detecting incident light, wherein the incident light comprises a reflection of the light beam from an object; and controlling an analog circuit coupled to one or more of the plurality of pixels to compare one or more of the detection signals to a reference signal and output a comparison signal associated with the one or more of the plurality of pixels.

Another embodiment of the present disclosure comprises a non-transitory computer readable medium comprising program code, which when executed, is configured to cause a processor to: control a beam transmitting device to transmit a light beam; detect incident light with an optical detector comprising a plurality of pixels, each of the plurality of pixels configured to generate a detection signal in response to detecting incident light, wherein the incident light comprises a reflection of the light beam from an object; and control an analog circuit coupled to one or more of the plurality of pixels to compare one or more of the detection signals to a reference signal and output a comparison signal associated with the one or more of the plurality of pixels.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1A is a simplified block diagram of an example light detection and ranging (LIDAR) system.

FIG. 1B shows an example embodiment of LIDAR interference mitigation according to the present disclosure.

FIG. 2 shows an example embodiment of LIDAR interference mitigation according to the present disclosure.

FIG. 3 shows an example embodiment of LIDAR interference mitigation according to the present disclosure.

FIG. 4 shows an example embodiment of LIDAR interference mitigation according to the present disclosure.

FIG. 5 shows a flow chart for one embodiment of a method for LIDAR interference mitigation according to the present disclosure.

FIG. 6 is a block diagram of an example computing system for implementing some of the examples described herein.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

A LIDAR system, also referred to as a laser detection and ranging (LADAR) system, is an active remote sensing system that can be used to obtain the range from a source to one or more points on a target. A LIDAR uses a light beam, typically a laser beam, to illuminate the one or more points on the target. Compared with other light sources, a laser beam may propagate over long distances without spreading significantly (highly collimated), and can be focused to small spots so as to deliver high optical power densities over long distance and provide fine resolution. The laser beam may be modulated such that the transmitted laser beam includes a series of pulses. The transmitted laser beam may be directed to a point on the target, which may reflect the transmitted laser beam. The laser beam reflected from the point on the target can be measured, and the time-of-flight (ToF) from the time a pulse of the transmitted light beam is transmitted from the source to the time the pulse arrives at a detector near the source or at a known location may be measured. The range from the source to the point on the target may then be determined by, for example, r=c×t/2, where r is the range from the source to the point on the target, c is the speed of light in free space, and t is the ToF of the pulse of the light beam from the source to the detector.

A LIDAR fires a laser and expects a reflection back on an array of pixels. The system expects the reflection on specific pixels (the pixels of interest). However, if there is interference, e.g., from another laser, other pixels may receive false signals. Embodiments of the present disclosure solve this problem using an array of high speed light sensors (referred to herein as pixels) fed into a comparing circuit. The comparing circuit determines (1) whether pixels outside of the pixels of interest are receiving the reflection, and (2) whether the pixels in the pixels of interest are receiving signals above a threshold. In some embodiments, the threshold may comprise a value associated with the strength of earlier received signals and/or the strength of signals received from pixels of interest. If pixels outside of the pixels of interest receive signals, then these signals may be discounted or may be ignored. Further, if the signals from the pixels of interest are weaker than the threshold and/or weaker than signals from outside the area of interest, they may also be discounted or ignored, thus reducing the impact of interference on a LIDAR system

In one example, a pixel array receives LIDAR light. The light is focused on one to four pixels. If the received light falls in the center of one pixel, only one pixel becomes active. If light were to fall between pixels, the optics and sensor are configured such that two to four pixels receive the light.

Continuing with the example, a multiple input, multiple output analog comparator is then used to compare signals received from every pixel in the array. In some embodiments, the output from each of the pixels is AC coupled to each input of the comparator. This makes the comparator sensitive to only the received pulses and not ambient lighting. The comparator further comprises a reference input, and thus will only detect pulses that exceed the reference input. In some embodiments, the comparator is designed to output the inputs that exceed the reference value. The comparator thus isolates the strongest signals, which correspond to the pixels with the most incident light. In some embodiments, signals from other pixels, e.g., those with less incident light are ignored. In other embodiments, signals received from pixels outside of the pixels of interest may be compared to signals received from the pixels of interest. In one such embodiment, if the light received from the pixels of interest is stronger, the system may determine that the light hitting the pixels of interest is not interference. Further, in such an embodiment, the system may determine that the light hitting pixels outside of the pixels of interest is likely interference. Thus reducing the impact of interference on the LIDAR system.

### Illustrative Embodiment of a System for LIDAR Interference Mitigation

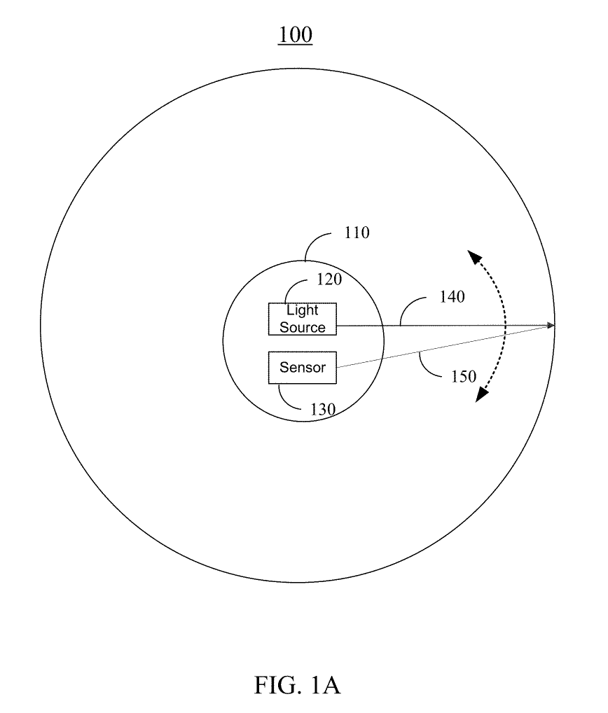

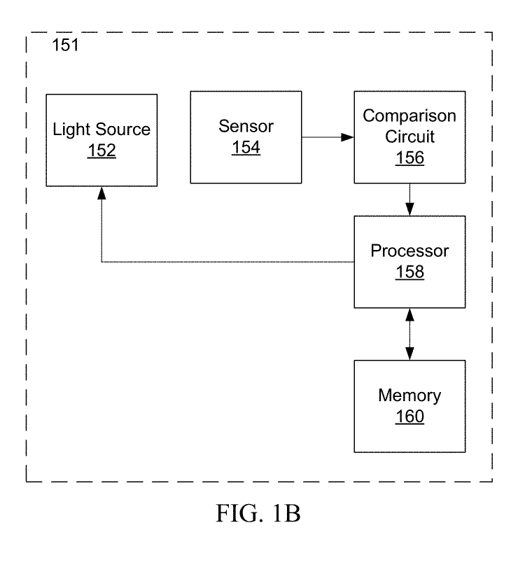

FIG. 1A is a simplified block diagram of an example LIDAR system 100. System 100 may include a scanning platform 110 that may be used to scan the laser beam in different directions. Scanning platform 110 may include a light source 120 and a sensor 130. Light source 120 may emit a light beam 140 toward a target object, which may reflect a portion of light beam 140 as a reflected beam 150. The reflected beam 150 may then be collected and detected by sensor 130.

Light source 120 may include an optical source, such as a laser, a laser diode, a vertical cavity surface-emitting laser (VCSEL), a light-emitting diode (LED), or other optical source. The laser may be, for example, an infrared pulsed fiber laser or other mode-locked laser with an output wavelength of, for example, 930-960 nm, 1030-1070 nm, around 1550 nm, or longer.

Sensor 130 may include a detector, or array of detectors, each having a working (sensitive) wavelength comparable with the wavelength of the light source 120. The detector may be a high speed photodetector, for example, a PIN photodiode with an intrinsic region between a p-type semiconductor region and an n-type semiconductor region, or an InGaAs avalanche photodetector (APD). In some systems, sensor 130 may include a silicon photomultiplier (SiPM) sensor.

Scanning platform 110 may use many different types of beam scanning mechanisms, for example, a rotating platform driven by a motor, a multi-dimensional mechanical stage, a Galvo-controlled mirror, a microelectromechanical (MEMS) mirror driven by micro-motors, a piezoelectric translator/transducer using piezoelectric material such as a quartz or lead zirconate titanate (PZT) ceramic, an electromagnetic actuator, or an acoustic actuator. Scanning platform 110 may be a platform without mechanical movement of any component, for example, using a phased array technique where phases of laser beams from lasers in a one-dimensional (1-D) or two-dimensional (2-D) laser array may be modulated to alter the wavefront of the superimposed laser beam.

As scanning platform 110 points light beam 140 at different directions using any beam scanning mechanism, such as the scanning mechanism described above, light beam 140 may illuminate different target objects or different locations of a target object during the scanning. During the scanning, reflected beam 150 from the different target objects or different locations of the target object may be collected and detected by sensor 130 to generate detection signals, which may then be used by an analyzer or a processor to determine the characteristics of the target objects, such as their distances from system 100 and their reflective properties, or generate an image of the scanned area. When scanning platform 110 revolves one round, LIDAR system 100 may perform measurements of a “slice” of the surrounding environment. Because the light spot of light beam 140 on the targets has a finite size (e.g., height and width), an image of a 2.5-dimensional (2.5-D) region of the environment may be generated.

To achieve a 3-dimensional (3-D) scanning of the environment, a LIDAR system may use either multiple sets of lasers/detectors or a 2-D scanning mechanism, such that the overall system can scan not only in one plane as shown in FIG. 1A, but also in a plurality of different planes.

Turning now to FIG. 1B, which shows an example system 151 for LIDAR interference mitigation according to the present disclosure. As shown in FIG. 1B, the system 150 comprises a light source 152, sensor 154, comparison circuit 156, processor 158, and memory 160.

In the embodiment shown in FIG. 1B, the light source 152 comprises one or more sources of light. For example, light source 152 may comprise one or more of a laser, a laser diode, a vertical cavity surface-emitting laser (VCSEL), a light-emitting diode (LED), or other optical source. The laser may be, for example, an infrared pulsed fiber laser or other mode-locked laser with an output wavelength of, for example, 930-960 nm, 1030-1070 nm, around 1550 nm, or longer. Further, in some embodiments, the output, direction, and/or strength of the light output by light source 152 may be controllable by processor 158.

Sensor 154 comprises one or more sensors configured to detect light output by light source 152 and reflected by one or more objects. In some embodiments, sensor 154 may comprise an array of sensors, e.g., an array of pixels, each having a working (sensitive) wavelength comparable with the wavelength of the light source 152. The sensor 154 may comprise one or more high speed photodetectors, for example, a PIN photodiode with an intrinsic region between a p-type semiconductor region and an n-type semiconductor region, or an InGaAs avalanche photodetector (APD). Further, in some embodiments, sensor 154 may include one or more silicon photomultiplier (SiPM) sensors.

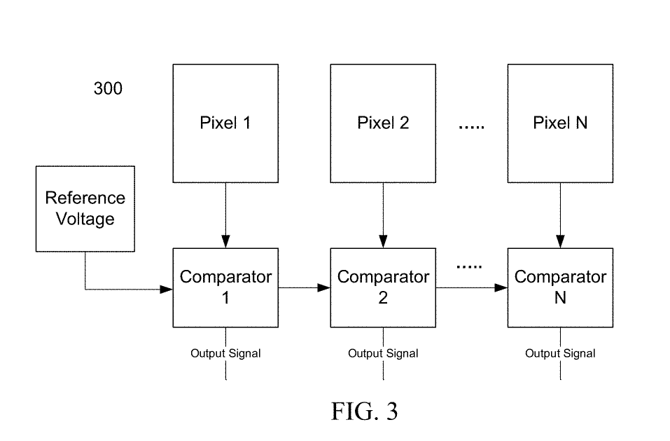

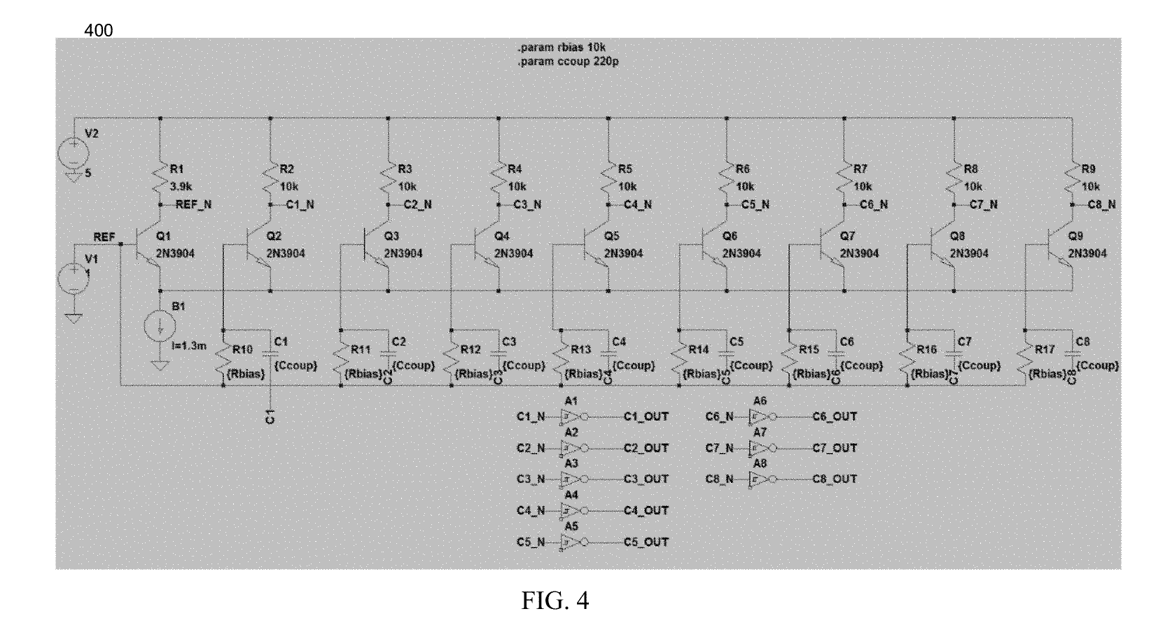

As shown in FIG. 1B, sensor 154 is configured to transmit one or more signals associated with detected light to a comparison circuit 156. In some embodiments, the comparison circuit 156 is configured to determine (1) whether pixels outside of the pixels of interest are receiving reflected light, and (2) whether the pixels in the pixels of interest are receiving signals associated with incident light with a strength that exceeds a threshold. In some embodiments, the threshold may comprise a value associated with the strength of earlier received signals and/or the strength of signals received from pixels of interest. In some embodiments, if pixels outside of the pixels of interest receive signals, then these signals may be discounted or may be ignored. Further, if the signals received from the pixels of interest are weaker than the threshold and/or weaker than signals from outside the area of interest, they may also be discounted or ignored, thus reducing the impact of interference on a LIDAR system. Thus, in some embodiments, the comparison circuit 156 may comprise a multiple input, multiple output analog comparator (e.g., a circuit similar to the circuit described with regard to FIG. 3 or 4). In some embodiments, this comparator may compare signals received from one or more pixels in the array.

The comparison circuit is configured to output signals to one or more processors 158. In the embodiment shown in FIG. 1B, the processor 158 is configured to control light source 152. Further, in some embodiments, the processor 158 is configured to control comparison circuit 156 to monitor specific pixels, e.g., pixels of interest on which the processor 158 determines there is likely to be incident light. Processor 158 may include without limitation one or more general-purpose processors, one or more special-purpose processors (such as digital signal processing (DSP) chips, graphics acceleration processors, application specific integrated circuits (ASICs), and/or the like), and/or other processing structures or means, which can be configured to perform one or more of the methods described herein.

The processor 158 is coupled to memory 160, which may comprise program code configured to be executed by processor 158 to perform operations described herein. Further, memory 160 may comprise storage for processor 158 to store data. In some embodiments, memory 160 may comprise local and/or network accessible storage, and/or can include, without limitation, a disk drive, a drive array, an optical storage device, a solid-state storage device, such as a random access memory (RAM), and/or a read-only memory (ROM), which can be programmable, flash-updateable and/or the like. Such storage devices may be configured to implement any appropriate data stores, including without limitation, various file systems, database structures, and/or the like.

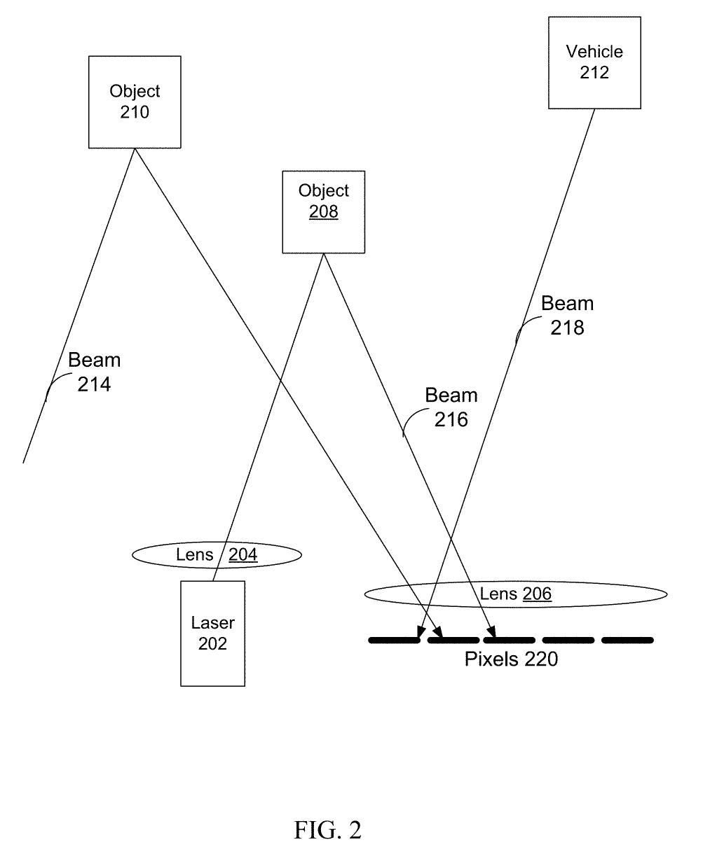

Referring to FIG. 2, which shows one embodiment of a LIDAR system. As shown in FIG. 2, laser 202 fires a laser beam 216 through lens 204 onto object 208. The beam 216 is reflected by object 208 through lens 206 onto an array of pixels 220. However, as shown in FIG. 2, the pixels 220 are further detecting interference beams 214 and 218, which are received from other sources, e.g., reflected off of object 210 or transmitted by vehicle 212. In some embodiments, these interference beams 214 and 218 will lead to incorrect results from the LIDAR system.

A person of skill in the art will recognize that FIG. 2 is not drawn to scale and that in other embodiments the operation of the light source, lenses, pixels, and other objects may be different than shown in FIG. 2. For example, the lenses may invert the location of detected objects and ether may be a larger array of pixels than shown in FIG. 2. Further, in some embodiments, there may be more pixels than shown in FIG. 2.

One embodiment of the present disclosure solves this problem by determining whether the incident reflected light is received by pixels of interest and also using a comparison circuit to confirm that the signal from the pixel exceeds a threshold. If pixels outside the area of interest receive incident light, or if the signal is below the threshold, that signal may be discounted or ignored. For example, in one embodiment, if incident light is received outside of the pixels of interest, that strength of that incident light may be compared to the strength of incident light received by the pixels of interest. If the incident light received outside of the pixels of interest is stronger than the incident light received by the pixels of interest, the system may determine that the incident light outside of the pixels of interest is likely interference. Thus, in some embodiments, this incident light may be discounted in determinations associated with detected objects. This enables a LIDAR system of the present disclosure to return results associated with only the intended beam 216 and not the interference beams 214 and 218.

Turning now to FIG. 3, which shows one embodiment of a system 300 for LIDAR interference mitigation according to the present disclosure. The system 300 shown in FIG. 3 shows one embodiment of a multiple input multiple output comparator. As shown in FIG. 3, each pixel outputs a signal to a comparator, which compares the signal to a reference voltage. In some embodiments, the comparator will provide an output signal from only the pixels with the strongest signal (e.g., the pixels with the most incident light). Further, in some embodiments the comparator may be configured to output signals from a pre-set number of pixels, e.g., the four pixels with the strongest signals. In some embodiments the comparator may comprise an op-amp circuit, a transistor circuit, or some other type of circuit known in the art. In other embodiments, the comparator may comprise a multiplexor configured to multiplex signals from the pixels of interest to a traditional comparator. In some embodiments, a second multiplexor could be used to transmit pixels outside of the area of interest to a second comparator.

Further, in some embodiments, a processor may control the inputs to the comparator circuits such that only pixels in an area of interest are monitored. In some embodiments, the pixels in the area of interest may comprise the pixels the processor has determined are likely to receive incident light (e.g., based on the expected return angle of reflected light). In some embodiments, the processor is configured to disregard signals that are from a pixel outside the area of interest, and/or below the threshold value.

Turning now to FIG. 4, which shows one embodiment of a system 400 for LIDAR interference mitigation according to the present disclosure. The system 400 shows one example embodiment of a multi input and output comparator. Other embodiments may comprise different circuit configurations and components, e.g., additional or different transistors or op-amps, along with other components such as resistors, capacitors, inductors, etc.

The embodiment shown in FIG. 4 comprises a reference voltage V1 and a bias current B1, along with a pull-up voltage V2. The reference voltage and current are coupled to reference transistor Q1, which in this embodiment is a 2N3904 transistor. The reference transistor further comprises a reference resistor R1 coupled to the base of Q1. This reference circuit provides a reference voltage for the multiple input multiple output comparator.

The embodiment shown in FIG. 4 comprises an eight input and eight output comparator. In one embodiment, this circuit may be coupled to an array of eight pixels. In such an embodiment, each pixel provides an input to the comparator at an input capacitor (shown as C1-C8). The input capacitor provides AC-coupling, so that ambient light will not be detected by the comparator. Each input capacitor is coupled to a bias resistor (shown as R10-R17), which is connected in series with the reference voltage and the collector of a transistor (shown as Q2-Q8), each of which, in this embodiment, is a 2N3904 transistor. The emitter of the transistor is coupled to the same bias current as the reference transistor Q1. The base of each transistor provides the output of the comparison circuit, and is coupled to a bias resistor (shown as R2-R9). The output of the comparator is then provided to an output buffer, shown as A1-A8, and in one embodiment may comprise a CMOS inverter with hysteresis. Specific values shown in FIG. 4, e.g., resistance values, capacitance values, voltage values, current values, or specific component numbers, are examples. In other embodiments different values or components may be used.

In some embodiments the comparator is biased such that the input signals must exceed the reference voltage V1, before any of the outputs are active. In some embodiments, the bias current B1 along with the collector resistor R1 (which may be implemented as a current source) is sized so that R1 can source all of the current sunk by B1. When one input exceeds the reference voltage, the collector (or drain if using FETs) of that circuit can sink a limited amount of current, since the collector has a higher value of resistance than the collector of the reference transistor (Q1). In some embodiments, this allows several, but not all of the transistors to pull the collector voltage down to a level that can be detected by the output buffer. In some embodiments, this buffer may comprise a CMOS inverter with hysteresis.

In some embodiments, a comparator of the type shown in FIG. 4, can be used with an array of silicon photomultiplier pixels or other sensors to indicate which sensor(s) exceed the reference voltage.

Further, in some embodiments, a processor, FPGA, PLC, or other similar component may implement logic to determine if the pixels of interest are active or if other pixels are stronger. If the active pixels are the pixels of interest, the comparator outputs can be used to trigger the comparator. If pixels other than the pixels of interest have a higher output, then the light entering the lens is likely to be from competing LIDAR units (e.g., the light is interference) and should be disregarded.

### Illustrative Embodiment of a Method for LIDAR Interference Mitigation

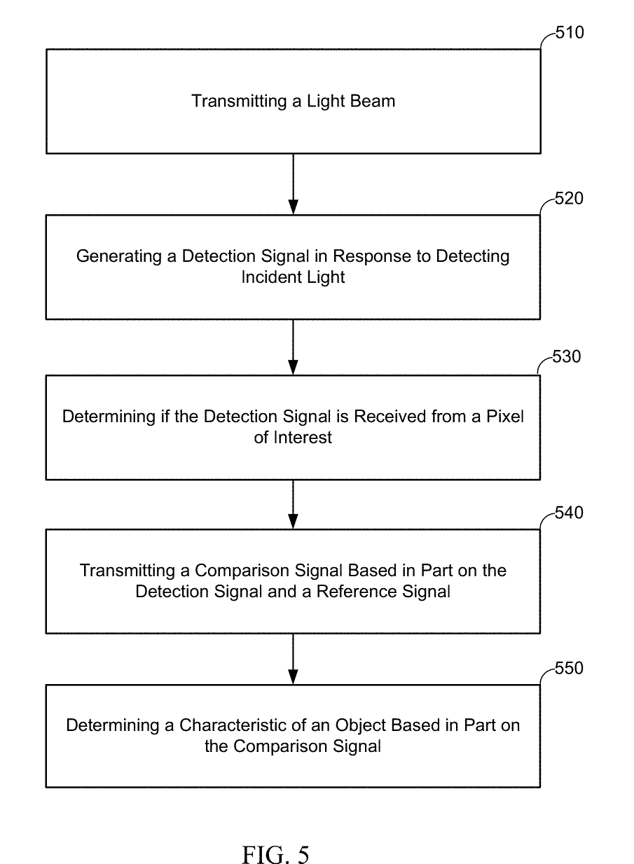

Referring to FIG. 5, which is a flow chart of steps for performing a method for LIDAR interference mitigation according to one embodiment. In some embodiments, the steps in FIG. 5 may be implemented in program code that is executed by a processor, for example, the processor in a general purpose computer, a mobile device, or a server. In some embodiments, these steps may be implemented by a group of processors. In some embodiments one or more steps shown in FIG. 5 may be omitted or performed in a different order. Similarly, in some embodiments, additional steps not shown in FIG. 5 may also be performed. The steps below are described with reference to components described above with regard to system 100 shown in FIG. 1.

The method begins at step 510 when a light beam is transmitted. For example, a processor associated with a light source 120 (e.g., a laser transmitter) may select a first set of laser emitters from a plurality of sets of laser emitters. In some embodiments, each of the emitters and their associated components are oriented to emit light in a forward direction. In some embodiments, the processor may be configured to determine emitters based in part on e.g., a location of a machine, a speed of a machine, a density of objects in the environment or parameters that may be used to determine the density of objects, types of nearby objects in the environment (e.g., people, vehicles, buildings, equipment, support beams, etc.), a type of operating environment (e.g., residential, rural, commercial, downtown, interstate, parking lot or garage, populated warehouse, unpopulated warehouse, etc.), a user preference, etc.

At step 520 a detection signal may be generated by a detector, such as sensor 130. In some embodiments the detector may comprise an array of pixels. In some embodiments the pixels may be configured to detect at least the portion of the light beam reflected from an object that is illuminated by the light beam. For example, the pixels may detect one or more of the detectable change in reflection, the detectable change in transmission, the detectable change in absorption, or the detectable combination thereof, of at least the portion of the light beam. In some embodiments, the detection signal may include a series of pulses.

At step 530, a processor determines if the detection signal is received from a pixel of interest. In some embodiments, the processor may determine that the pixel is within a range of pixels that is expected to receive incident light, e.g., because of an expected reflection from an object within range of the light source 120.

At step 540, a comparison circuit, such as the circuit described with regard to FIGS. 3 and 4 transmits a comparison signal. The comparison signal comprises a comparison of the detection signal to a reference signal. In some embodiments, the comparison circuit may be configured to output a comparison signal associated with a set number of pixels, e.g., only outputting a comparison signal from the four pixels with the most incident light. In other embodiments, the comparison circuit may be configured to output a comparison signal from only the pixels that output a detection signal exceeding a predetermined threshold. In some embodiments, the threshold may comprise a pre-set value. In other embodiments, the threshold may comprise a value associated with previously received signals, e.g., signals received by the pixels of interest. Thus, the comparison signal may indicate whether the incident light is more direct than incident light previously received. It may also indicate whether the incident light outside of the pixels of interest exceeds the strength of the incident light received by the pixels of interest.

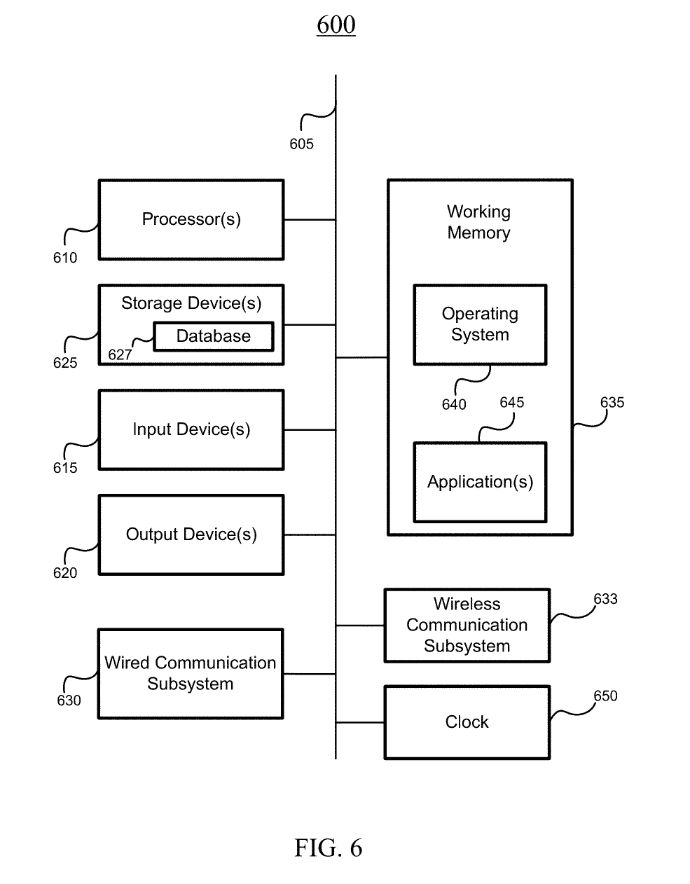

At step 550, based at least partially on the detection signal, a processor, such as processor 610 as illustrated in FIG. 6 and described in detail below, may determine the characteristics of an object. In some embodiments, this characteristic may comprise a distance to the object or data associated with movement of the object. In some embodiments, the processor may determine the characteristics based in part on, for example, the time when the light beam crosses the boundary of two lenses and the scanning speed of the light beam.

FIG. 6 illustrates components of an example computing system 600 for implementing some of the examples described herein. For example, computing system 600 can be used to control scanning platform 110, light source 120, and sensor 130 of FIG. 1A, and/or the comparison circuits discussed throughout this disclosure. It should be noted that FIG. 6 is meant only to provide a generalized illustration of various components, any or all of which may be utilized as appropriate. Moreover, system elements may be implemented in a relatively separated or relatively more integrated manner.

Computing system 600 is shown comprising hardware elements that can be electrically coupled via a bus 605 (or may otherwise be in communication, as appropriate). The hardware elements may include a processing unit 610, one or more input devices 615, and one or more output devices 620. Input device(s) 615 can include without limitation camera(s), a touchscreen, a touch pad, microphone(s), a keyboard, a mouse, button(s), dial(s), switch(es), and/or the like. Output devices 620 may include without limitation a display device, a printer, LEDs, speakers, and/or the like.

Processing unit 610 may include without limitation one or more general-purpose processors, one or more special-purpose processors (such as digital signal processing (DSP) chips, graphics acceleration processors, application specific integrated circuits (ASICs), and/or the like), and/or other processing structures or means, which can be configured to perform one or more of the methods described herein.

Computing system 600 can also include a wired communication subsystem 630 and a wireless communication subsystem 633. Wired communication subsystem 630 and wireless communication subsystem 633 can include, without limitation, a modem, a network interface (wireless, wired, both, or other combination thereof), an infrared communication device, a wireless communication device, and/or a chipset (such as a Bluetooth™ device, an Institute of Electrical and Electronics Engineers (IEEE) 802.11 device (e.g., a device utilizing one or more of the IEEE 802.11 standards described herein), a WiFi device, a WiMax device, cellular communication facilities, etc.), and/or the like. Subcomponents of the network interface may vary, depending on the type of computing system 600. Wired communication subsystem 630 and wireless communication subsystem 633 may include one or more input and/or output communication interfaces to permit data to be exchanged with a data network, wireless access points, other computer systems, and/or any other devices described herein.

Depending on desired functionality, wireless communication subsystem 633 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN and/or WPAN.

Computing system 600 of FIG. 6 may include a clock 650 on bus 605, which can generate a signal to synchronize the various components on bus 605. Clock 650 may include an LC oscillator, a crystal oscillator, a ring oscillator, a digital clock generator such as a clock divider or clock multiplexer, a phase locked loop, or other clock generator. The clock may be synchronized (or substantially synchronized) with corresponding clocks on other devices while performing the techniques described herein.

Computing system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random access memory (RAM), and/or a read-only memory (ROM), which can be programmable, flash-updateable and/or the like. Such storage devices may be configured to implement any appropriate data stores, including without limitation, various file systems, database structures, and/or the like. For instance, storage device(s) 625 may include a database 627 (or other data structure) configured to store detected signals as described in embodiments herein.

In many embodiments, computing system 600 may further comprise a working memory 635, which can include a RAM or ROM device, as described above. Software elements, shown as being currently located within working memory 635, can include an operating system 640, device drivers, executable libraries, and/or other code, such as one or more application programs 645, which may comprise software programs provided by various embodiments, and/or may be designed to implement methods, and/or configure systems, provided by other embodiments, as described herein, such as some or all of the methods described in relation to FIG. 5. Merely by way of example, one or more procedures described with respect to the method discussed above might be implemented as code and/or instructions executable by a computer (and/or a processor within a computer). In an aspect, such code and/or instructions can be used to configure and/or adapt a general purpose computer (or other device) to perform one or more operations in accordance with the described methods.

A set of these instructions and/or code might be stored on a non-transitory computer-readable storage medium, such as non-transitory storage device(s) 625 described above. In some cases, the storage medium might be incorporated within a computer system, such as computing system 600. In other embodiments, the storage medium might be separate from a computer system (e.g., a removable medium, such as a flash drive), and/or provided in an installation package, such that the storage medium can be used to program, configure, and/or adapt a general purpose computer with the instructions/code stored thereon. These instructions might take the form of executable code, which is executable by computing system 600 and/or might take the form of source and/or installable code, which, upon compilation and/or installation on computing system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein may be presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

1. A system comprising:
a beam transmitting device configured to transmit a light beam;
an optical detector comprising a plurality of pixels, each of the plurality of pixels configured to generate a detection signal in response to detecting incident light, wherein the incident light comprises a reflection of the light beam from an object; and
an analog circuit coupled to one or more of the plurality of pixels and configured to compare one or more of the detection signals to a reference signal and output a comparison signal associated with the one or more of the plurality of pixels.

2. The system of claim 1, further comprising a plurality of analog circuits, and wherein each of the plurality of pixels is coupled to one of the plurality of analog circuits.

3. The system of claim 1, further comprising a processor configured to:
receive the comparison signal;
determine whether the comparison signal is associated with a pixel of interest; and
if the comparison signal is not from a pixel of interest, determine whether the comparison signal is stronger than a signal received from the pixel of interest.

4. The system of claim 3, wherein the processor is further configured to determine a characteristic of the object based in part on the comparison signal.

5. The system of claim 4, wherein the characteristic of the object comprises a distance to the object.

6. The system of claim 1, wherein the analog circuit comprises an analog comparator circuit.

7. The system of claim 1, wherein the analog circuit is further configured to identify one or more strongest detection signals and output comparison signals based on only the strongest detection signals.

8. A method comprising:
controlling a beam transmitting device to transmit a light beam;
detecting incident light with an optical detector comprising a plurality of pixels, each of the plurality of pixels configured to generate a detection signal in response to detecting incident light, wherein the incident light comprises a reflection of the light beam from an object; and
controlling an analog circuit coupled to one or more of the plurality of pixels to compare one or more of the detection signals to a reference signal and output a comparison signal associated with the one or more of the plurality of pixels.

9. The method of claim 8, wherein each of the plurality of pixels is coupled to one of a plurality of analog circuits.

10. The method of claim 8, further comprising:
receiving the comparison signal;
determining whether the comparison signal is associated with a pixel of interest; and
if the comparison signal is not from a pixel of interest, determining whether the comparison signal is stronger than a signal received from the pixel of interest.

11. The method of claim 10, further comprising determining a characteristic of the object based in part on the comparison signal.

12. The method of claim 11, wherein the characteristic of the object comprises a distance to the object.

13. The method of claim 8, wherein the analog circuit comprises an analog comparator circuit.

14. The method of claim 8, wherein the analog circuit is further configured to identify one or more strongest detection signals and output comparison signals based on only the strongest detection signals.

15. A non-transitory computer readable medium comprising program code, which when executed by a processor is configured to cause the processor to:
control a beam transmitting device to transmit a light beam;
detect incident light with an optical detector comprising a plurality of pixels, each of the plurality of pixels configured to generate a detection signal in response to detecting incident light, wherein the incident light comprises a reflection of the light beam from an object; and
control an analog circuit coupled to one or more of the plurality of pixels to compare one or more of the detection signals to a reference signal and output a comparison signal associated with the one or more of the plurality of pixels.

16. The non-transitory computer readable medium of claim 15, wherein each of the plurality of pixels is coupled to one of a plurality of analog circuits.

17. The non-transitory computer readable medium of claim 15, further comprising program code, which when executed by the processor is configured to cause the processor to:
receive the comparison signal;
determine whether the comparison signal is associated with a pixel of interest; and
if the comparison signal is not from a pixel of interest, determine whether the comparison signal is stronger than a signal received from the pixel of interest.

18. The non-transitory computer readable medium of claim 17, further comprising program code, which when executed by the processor is configured to cause the processor to determine a characteristic of the object based in part on the comparison signal.

19. The non-transitory computer readable medium of claim 18, wherein the characteristic of the object comprises a distance to the object.

20. The non-transitory computer readable medium of claim 15, wherein the analog circuit is further configured to identify one or more strongest detection signals and output comparison signals based on only the strongest detection signals.
